(19) United States
(12) Patent Application Publication
(10) Pub. No.: US 2003/0174810 A1
(43) Pub. Date: Sep. 18, 2003

(54) Method and apparatus for destroying microbial contamination of mail

(75) Inventors: Sergey A. Korenev, Mundelein, IL (US); Anton S. Korenev, Springfield, NJ (US)

Correspondence Address: Thomas E. Kocovsky, Jr., FAY, SHARPE, FAGAN, MINNICH & McKEE, LLP, Seventh Floor, 1100 Superior Avenue, Cleveland, OH, 44114-2518, US

(73) Assignee: STERIS INC.

(21) Appl. No.: 10/095,869

(22) Filed: Mar. 12, 2002

(51) Int. Cl. G21K 5/10

(52) U.S. Cl. 378/69; 378/64; 250/492.3

(57) ABSTRACT

A powder of Anthrax spores or other microbial contamination in a series of conveyed envelopes or banknotes (2) are deactivated by pulses of energy. Preferably, the deactivation occurs in the normal processing and sorting of mail or paper currency. The pulsed energy is in the form of low kinetic energy (under 500 keV) e⁻ beams (12) or x-rays which are pulsed in coordination with the movement of mail in the mail handling equipment or the movement of banknotes into or out of an automatic teller machine. The treatment of either mail or currency is done under nearly adiabatic conditions.

### BACKGROUND OF THE INVENTION

The present application relates to the destruction of microbes on relatively thin paper or plastic carriers. It finds particular application in conjunction with killing Anthrax spores and other biological contaminants in mail and will be described with particular reference thereto. It will also find application in the treatment of other thin items such as bank notes, tickets, checks, receipts, and the like.

Biological terrorism through the mails has become a serious problem. Recent events have shown the ease with which bioterrorists can deliver Anthrax and other biological weapons to targets using the postal system.

There are numerous known decontaminating systems. These include radiation, x-rays, e⁻ beams, and ultraviolet light, plasma methods on the basis of etching with glow discharge, gas decontamination, and ozone decontamination.

High energy electron beams are ill-suited for destroying microbes in the mail. High-energy electrons, with a kinetic energy in the range of 5-10 MeV use large electron accelerators and need relatively large radiation shields for safety. Moreover, these systems are very expensive and need specialized staff to operate them. Further, the electron beam delivers a very high Joule energy over a limited penetration range. This energy leads to heating not only of the microbes, but also of the surrounding envelopes. This can lead to overheating of the envelopes and other paper in the mail, possibly causing combustion. This heating can also soften plastic materials in the mail leading to its deformation and thermal bonding with surrounding materials. Heat can also destroy security characteristics of bank notes.

Gamma radiation, due to its greater penetrating power, is more amenable to bulk decontamination of mail. However, this same increased penetrating power increases the necessary shielding. Typically, very thick containment rooms are needed. When radioisotopes are used as the radiation source, heavy water containment tanks are needed and depleted radioactive waste issues arise. X-rays generated through x-ray vacuum tubes are highly energy consumptive, generate large amounts of waste heat, and have similar shielding problems to gamma radiation.

Plasma radiation methods are effective for killing microbes in the air and on surfaces. However, plasma discharge is not amenable to killing microbes inside of envelopes.

Ozone and other toxic gas methods are effective for killing microbes. However, obtaining penetration into envelopes or other paper products is slow. For toxic gases, further time is needed to evacuate the toxic gas back out of the interior of the envelopes at the end of the process. Also, strong oxidants, such as ozone, may alter some inks and dyes in any printing on or in the envelopes.

The present application provides a new and improved irradiation system that overcomes the above-referenced problems and others.

### SUMMARY OF THE INVENTION

In accordance with one aspect of the present application, an apparatus is provided for decontaminating flat objects. As used herein, “decontaminate” or “decontaminating” shall mean the attainment of any level of cleanliness in the spectrum ranging from sanitization through disinfection through high level disinfection through sterilization. A conveying system moves the flat objects through a treatment chamber. A source of radiation generates radiation while the flat object is in the treatment chamber. A sensor senses the flat object entering the treatment chamber and a trigger circuit triggers the radiation source to irradiate the flat object as it passes through the treatment chamber.

In accordance with another aspect of the present application, an apparatus is provided for irradiating mail. A mail handling conveyor system moves pieces of mail through the treatment chamber at relatively high rates of speed. A sensor senses a piece of mail entering the treatment chamber and a trigger circuit triggers a radiation source that irradiates the piece of mail as it passes through the treatment chamber.

In accordance with another aspect of the present application, a method is provided for decontaminating thin, flat objects without destroying the security signs and other things. Flat objects are passed individually along a conveying path. Each flat object is irradiated with a burst of radiation as it passes through the radiation beam.

In accordance with another aspect of the present application, a method is provided for decontaminating paper currency without destruction of the currency itself or of the security signs of the currency. The electron beam has a cross-section comparable to the size of banknotes.

In accordance with another aspect of the present application, a method of irradiating mail is provided. The method combines the beam irradiation and thermal sterilization using the heating of product in adiabatic conditions. The dissipation of beam energy in irradiated mail allows it to receive temperatures higher than 200° C. for thermal destruction of spores, such as Anthrax. Individual pieces of mail pass rapidly along a conveying path. Each piece of mail is irradiated with a burst of radiation as it passes. The electron beam has a cross-section comparable to the dimensions of conventional envelopes. The electron beam has a large cross section like with dimensions of envelopes or banknotes.

In accordance with another aspect of the present application, the method of irradiating mail combines beam irradiation and thermal deactivation. Through irradiation, the mail is heated to a temperature of about 200 degrees Celsius, a temperature believed to be sufficient to deactivate Anthrax and other spores.

In accordance with a more limited aspect of the present invention, the irradiated flat objects are one of mail, currency, and tickets.

In accordance with another more limited aspect of the present invention, the radiation includes electrons with energies under 500 keV or a combination of electrons and x-rays.

In accordance with another aspect of the present application, irradiation of flat objects with electrons having kinetic energies of less than or equal to about 500 keV heats the flat objects to a temperature sufficient to deactivate microbial contamination.

In accordance with another aspect of the present application, a method that is capable of deactivating spores, such as Anthrax spores, by electron irradiation and irradiation induced, thermal treatment is provided.

One advantage of the present application resides in its capability to deactivate microbial contamination such as, but not limited to, bacteria, viruses and spores on paper currency without damaging the currency itself or the security aspects of the paper currency.

One advantage of the present invention resides in its efficiency of destruction of spores (using radiation and thermal sterilization).

One advantage of the present invention resides in its safety relative to security signs for paper currency and other security documents.

One advantage of the present invention resides in its speed.

Another advantage of the present invention resides in its low shielding requirements.

Another advantage of the present invention resides in its high operator safety.

Another advantage of the present invention resides in its modest cost and simplicity of operation.

Still further advantages of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating a preferred embodiment and are not to be construed as limiting the invention.

FIG. 1a is a diagrammatic illustration of a mail or other flat object decontaminating system;

FIG. 1b is illustrative of the irradiation of spores in an envelope;

FIG. 2a is a diagrammatic illustration of a more detailed system for irradiating mail or other flat objects in accordance with the present invention;

FIG. 2b is an alternate embodiment of the system of FIG. 2a; and,

FIG. 2c is another alternate embodiment of the system of FIG. 2a.

### DETAILED DESCRIPTION OF THE PREFERRED EMBODIMENTS

Broadly stated, an apparatus and method are provided that capable of destroying microbial contamination on both mail and paper currency. As used herein, microbial contamination shall refer to bacteria, viruses, spores, pathogenic biological material and other biological material capable of deactivation by radiative means.

### Deactivation of Microbial Contamination on Mail

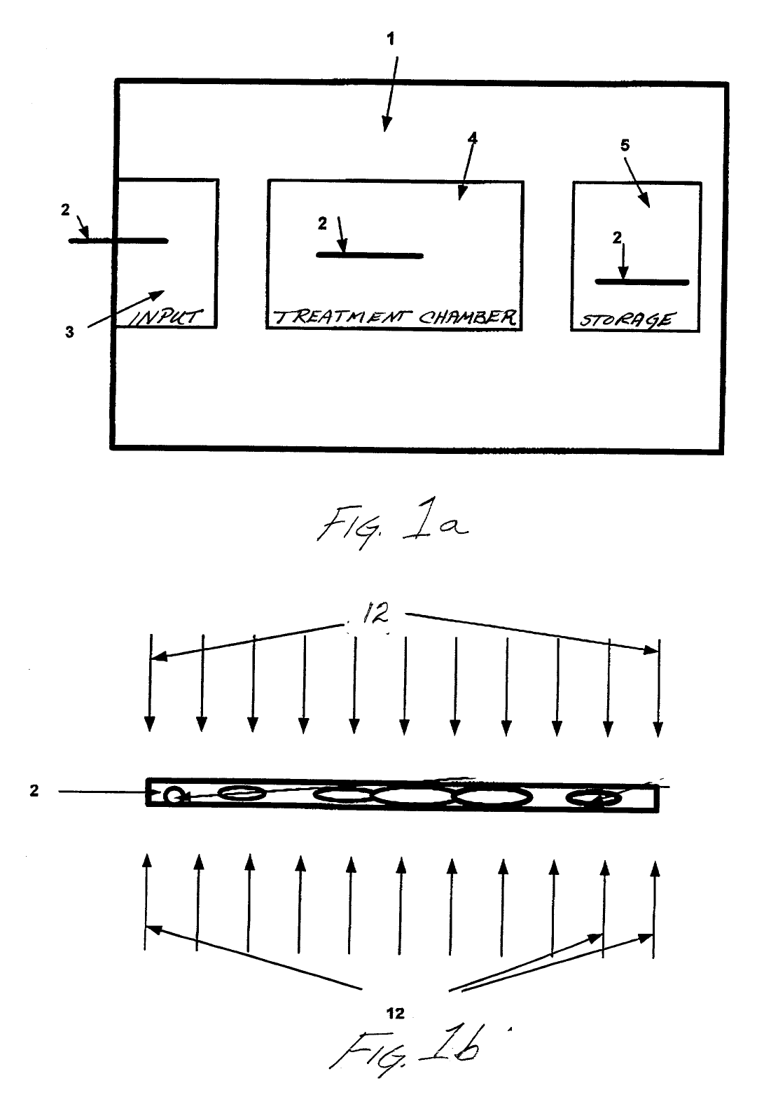

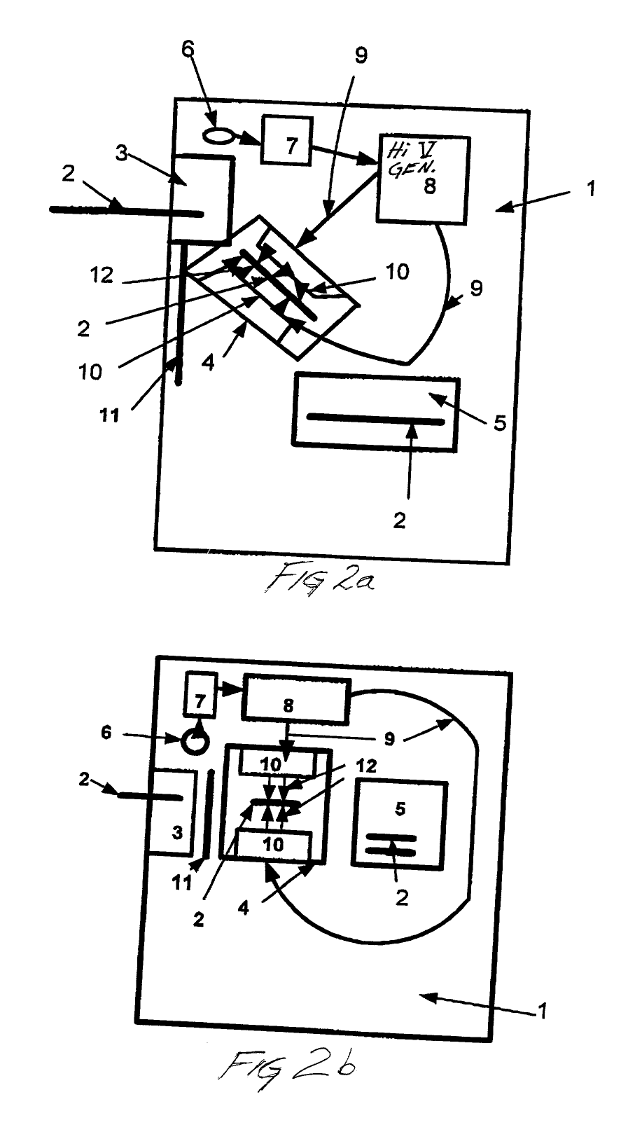

With reference to FIG. 1a, an apparatus 1 receives a rapid supply of individual envelopes 2 traveling longitudinally at high speed substantially end-to-end. As an envelope enters an input 3, it is identified and the power supply is actuated such that when the envelope 2 enters a treatment chamber 4, it is irradiated. Energy from the radiation is absorbed by ionization and collision with atoms and molecules of microbial contamination on and in the envelope leading to its deactivation. It is believed in one instance that in the case of microbes, the impact energy of the beam damages the microbe's DNA on a genetic level. It is further believed that thermal energy produced within the microbes resulting from the irradiation of the microbes deactivates the microbes. After being treated, the envelopes move to further processing stations or a storage box 5.

As illustrated in FIG. 1b, the envelopes 2 hold the Anthrax spores and other microbial contamination against movement. In other paper products, microbes are analogously held in pores of the paper. It is believed in one instance that a pulsed energy beam 12 alters the genetic codes of the stationary microbes, thus deactivating the microbes, without destroying the envelope and other surrounding materials. In another instance, it is believed that thermal energy absorbed by the microbes as a result of the irradiation deactivates the microbes.

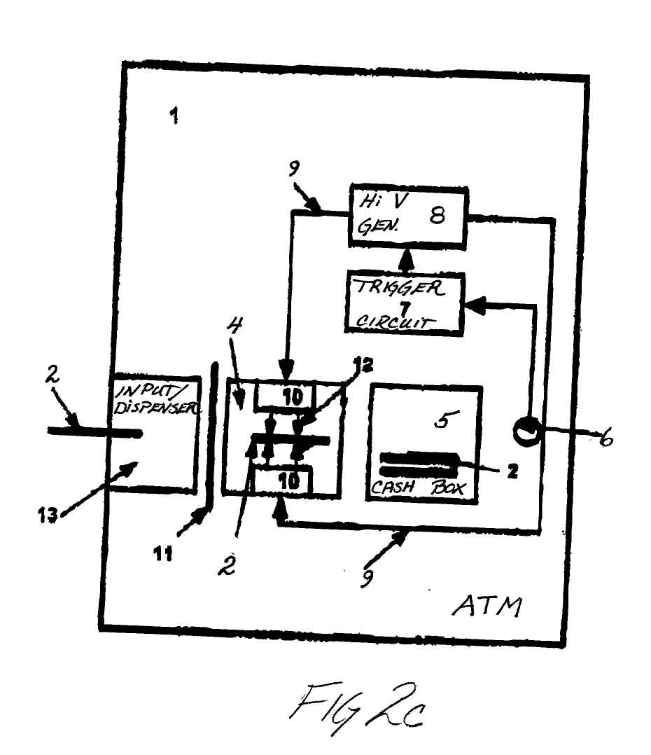

With reference to FIG. 2a, when an envelope 2 enters the input 3, a sensor 6 sends a signal to a trigger signal generator 7. The trigger signal generator triggers a pulse of a pulsed high voltage generator 8 to output one or more voltage pulses. The pulsed high voltage generator or power supply supplies pulses of energy by cables 9 to an electron or e⁻ beam generator 10. The e⁻ beam generator is a low energy e⁻ beam generator, i.e., 500 keV or less that generates e⁻ beam pulses on the order of nanoseconds to microseconds in duration. In the preferred mail treatment embodiment, the e⁻ beam generator is a 500 keV generator that irradiates each sensed envelope for 100-500 nanoseconds. This produces about a 60 kilogray (kGy) radiation dose for one pulse. The government currently recommends a 50 kGy dose of radiation to deactivate Anthrax spores. Of course, the pulse duration and its energy will be adjusted to accommodate the type of microbes or microbial contamination to be deactivated. In other embodiments, for less radiation resistant microbial contamination, an electron beam with an energy of only a few hundred electron volts may suffice to deactivate the microbial contamination. A 10 nanosecond pulse at 100 keV produces a 3 kGy dose which is sufficient to deactivate many common bacteria. Strophylococcus aureus, for example, is deactivated with a 0.65-2.6 kGy radiation dose. Bacillus sublilis is deactivated with a 2.6-12.9 kGy dose.

Preferably, a pair of the low energy e⁻ beam generators 10 is disposed on opposite sides of the envelope. At 200 keV, the e⁻ beams have very limited penetrating power, but are sufficient to penetrate normal thickness envelopes. However, because the penetration power is comparable with the thickness of conventional envelopes, relatively minor amounts of radiation shielding 11 are sufficient to prevent stray electrons from reaching the environment.

The timing and speed of the mail handling equipment that moves the mail from inlet 10 to the treatment chamber 4 is coordinated with the speed of the trigger pulse generator 7 and the high voltage generator 8 such that the electron beam is formed when the envelope enters and as it passes through the chamber. After the envelope has been irradiated, it is passed to further mail handling and sorting equipment or stored in a buffer area.

The throughput of envelopes on the mail conveyor is determined by the repetition rate of a pulsed, high voltage generator used to produce the electron beam. When the cross-section of the electron beam is comparable in size to the envelopes, an envelope process rate on the order of the repetition rate of the high voltage generator, used to generate the electron beam, is preferred. As is known in the industry, about 25% to 60% of the electron beam actually treats the microbial contamination in and/or on the mail. With a 500 kV high voltage generator, the maximum repetition rate of the generator is typically about 1 kHz. Thus, it is possible to treat about 1,000 envelopes/second with the method of the present application.

With reference to FIG. 2b, the envelope 2 passes more directly from the input 3 to the treatment chamber 4. This facilitates higher mail handling speeds. A radiation shield 11 is placed between the input and the treatment chamber to prevent scattered and stray electrons from escaping at the input 3. In one embodiment, the shield 11 is in the form of a shutter that moves into position between the passage of each piece of mail. Alternately, the shield 11 is in the form of a stationary plate with a thin slot. The shield 11 can have an enlarged thickness adjacent the slot to prevent radiation at an acute angle from exiting. Once in the treatment chamber 4, the mail can pause during treatment or can be treated during continuous movement. The presence of incoming mail is again sensed by a sensor 6 causing a trigger pulse generator 7 to generate a trigger pulse that causes a high voltage generator 8 to supply a high voltage pulse to the e⁻ beam generators 10. The timing of the production of the e⁻ beams relative to the mail handling system is selected such one or more 20 nanosecond e⁻ beam pulses are generated during the time that the envelope is between the e⁻ beam generators. Preferably, the e⁻ beam is relatively wide enough to encompass the entire envelope in one shot. Alternately, the e⁻ beam is smaller than the envelope; but, the envelope is conveyed through the conveyor system such that the entire envelope is exposed to the e⁻ beam over two or more pulses. In this manner, deactivation of the microbial contamination contained within the envelope is effected.

Preferably, the treatment chamber 4 is built around a portion of the conveying system of in-place mail handling equipment. Alternately, a short extension or an additional section of the same mail conveyor system is placed in a mail sorting machine currently in use to move the mail through the treatment chamber 4.

In the treatment of Anthrax spores, it is believed that electrons having a kinetic energy ranging from about 100 KeV to about 1,000 KeV (or equivalently, 1 MeV) are sufficient to deactivate the Anthrax spores. A combination of energetic electrons and x-rays can also be used to decontaminate mail housing Anthrax spores. In this regard, as known to those skilled in the art, x-rays can be produced from the electron beam. Both the electron beam and the x-rays can then be directed toward a source of Anthrax spores or other microbial contamination for deactivation.

It is also believed that the Anthrax spores are deactivated by the coupling of electron-irradiation damage done to the DNA of Anthrax spores and the irradiation induced thermal heating of the Anthrax spores to at least about 200° C.

### Deactivation of Microbial Contamination on Paper Currency

In an automatic teller machine embodiment (see FIG. 2c), an ATM 1 receives bills 2 at an input dispenser 13. The bills move at a slower speed through an irradiation chamber 4 into a cash storage box 5. In ATMs, vending machines or ticket dispensers, the treatment chamber 4 is again built around a portion of the conveying or handling system.

The banknotes, tickets, or the like 2 are stored in a hopper 5. As a bank note is fed out of the hopper, a sensor 6 causes a trigger circuit 7 to cause a power supply 8 to actuate e⁻ beam generators 10. Once the bill is irradiated, it is dispensed to the customer through the dispenser 13.

In the case of decontaminating paper currency, electrons having an energy ranging from about 0.2 to about 25 KeV are believed to be sufficient to deactivate contamination on the surfaces thereof. One can also use a combination of electrons and soft x-rays, the soft x-rays produced from a cathode plasma, i.e., a plasma produced in the neighborhood of a cathode of a high voltage generator used to produce the beam of electrons, to decontaminate paper currency; however, electrons are the preferred vehicle for such decontamination. As is well known to those skilled in the art, x-rays can be produced from an electron beam. Both forms of radiation, i.e., electrons and x-rays, can then be used to deactivate microbial contamination on paper currency.

As mail, banks notes or paper currencies are irradiated, they absorb energy. In the case of e⁻ beam irradiation, Joule heat is dissipated to the depth of the e⁻ beam penetration. In the case of banknotes and mail, such heating may have deleterious effects. For example, such heating effects could adversely affect the security mechanism of at least some banknotes. In the case of mail, such heating effects could also soften adhesives used to seal envelopes, darken thermal printed labels, or simply destroy the paper of the envelopes. To overcome these deleterious effects, pulsed electron beams are used to irradiate flat objects. It is believed that the difference between the length in time duration of the pulses of e⁻ beams used (i.e., nanoseconds) and the length of times typically associated with the aforementioned chemical processes of degradation (i.e., microseconds to milliseconds) results in a nearly adiabatic treatment of the flat objects. In other words, the chemical processes involved to bring about the aforementioned degradations take anywhere from about 1,000 to about 1,000,000 times longer to play out than the time of exposure to one pulse of deactivating electrons.

The use of a pulsed electron beam also provides for a high dose of radiation without the need of a high power accelerator. By using a pulsed system, dosage levels ranging anywhere from about 30 to about 60 kGy can be attained without significant heating of the flat objects irradiated.

Although described in terms of e⁻ beam generators, it is to be appreciated that the same system may be used for x-ray or gamma-ray decontamination. The high energy e⁻ beam pulses can be applied to one or more of a bank of high energy x-ray tubes to effect an emission of x-ray pulses.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiment, the invention is now claimed to be:

1. An apparatus for microbially decontaminating flat objects comprising:
a conveyor system for moving the flat objects through a treatment chamber;
a source of radiation for generating radiation while the flat object is in the treatment chamber;
a sensor for sensing a flat object entering the treatment chamber;
a trigger circuit for triggering the radiation source to irradiate the flat object as it passes through the treatment chamber.

2. The apparatus as set forth in claim 1 wherein the object is paper.

3. The apparatus as set forth in claim 1 wherein the object is one of a letter, a bank note, and a ticket.

4. The apparatus as set forth in claim 1 further including a second radiation source, the first and second radiation sources being disposed on opposite sides of the conveyor system.

5. The apparatus as set forth in claim 1 wherein the radiation source is an e⁻ beam source.

6. The apparatus as set forth in claim 5 wherein the e⁻ beam source generates pulses of electrons, the electrons having a kinetic energy of 100-500 keV and the pulses lasting 20-1000 nanoseconds.

7. The apparatus as set forth in claim 6 wherein the kinetic energy is about 200 keV and the pulses last about 20 nanoseconds.

8. The apparatus as set forth in claim 6 wherein the kinetic energy is about 500 keV and the pulses last about 100-500 nanoseconds.

9. The apparatus as set forth in claim 5 wherein the flat objects are potentially infected with Anthrax spores and the e⁻ beam source delivers a 50-100 kGy radiation dose to each object as it moves through the treatment chamber.

10. The apparatus as set forth in claim 5 wherein the flat objects are potentially infected with Strophylococcus aureus and the e⁻ beam source delivers a 0.65-6.0 kGy radiation dose to each object as it moves through the treatment chamber.

11. The apparatus as set forth in claim 5 wherein the flat objects are potentially infected with Bacillus sublilis and the e⁻ beam source delivers a 2.5-30 kGy radiation dose to each object as it moves through the treatment chamber.

12. The apparatus as set forth in claim 1 wherein the radiation source delivers a 0.65 250 kGy radiation dose to each object as it moves through the treatment chamber.

13. The apparatus as set forth in claim 1 wherein the flat objects are bank notes and further including:
a cash storage box in which bank notes are stored; and
a dispenser port from which banknotes are dispensed, the conveyor system conveying banknotes from the cash storage box to the dispenser port through the treatment chamber.

14. The apparatus as set forth in claim 13 wherein the conveyor system further conveys banknotes deposited at the dispenser port through the treatment chamber to the cash storage box.

15. The apparatus of claim 1, wherein the source of radiation produces an electron beam having a cross-section comparable in size to the area of an irradiated envelope.

16. A method of decontaminating thin, flat objects containing microbial contamination, comprising:
passing individual flat objects along a conveying path;
irradiating each flat object with a burst of radiation as it passes a source of e⁻ beams.

17. The method as set forth in claim 16 wherein the flat objects are one of: mail, currency, and tickets.

18. The method as set forth in claim 16 wherein the radiation includes electrons with an energy below 100 keV.

19. The method as set forth in claim 16 wherein the radiation includes x-rays and electrons.

20. The method as set forth in claim 16 wherein the irradiating step includes:
irradiating the objects concurrently from opposite sides.

21. The method as set forth in claim 16 wherein the irradiation step includes:
pulsing an electron beam to generate pulses of 20-1000 nanoseconds.

22. The method as set forth in claim 21 wherein the irradiating step further includes:
generating electron beam pulses of electrons of 100-500 keV.

23. The method as set forth in claim 16 wherein the irradiating step further includes:
delivering a 0.65-250 kGy radiation dose to each object.

24. The method as set forth in claim 16 wherein the flat objects are banknotes and further including:
conveying banknotes from a cash box through a treatment region to a banknote port;
triggering the irradiating step as each banknote moves through the treatment region.

25. The method as set forth in claim 24 further including:
receiving deposited banknotes at the banknote port;
conveying the deposited banknotes through the treatment region to the cash box;
triggering the irradiating step as each deposited banknote moves through the treatment region.

26. The method of claim 16, further including the step of heating, under nearly adiabatic conditions, the microbial contamination, the heat created by the irradiation step.

27. The method of claim 26, wherein the flat objects are one of letters and paper currency.
